(19) United States
(12) Patent Application Publication
(10) Pub. No.: US 2015/0163668 A1
(43) Pub. Date: Jun. 11, 2015

(54) PROTECTING SYSTEM AND METHOD FOR PRIVACY INFORMATION IN MOBILE TERMINAL

(71) Applicant: Tsinghua University, Beijing (CN)

(72) Inventors: Yongwei WU, Beijing (CN); Kai HUANG, Beijing (CN); Kang CHEN, Beijing (CN); Huan FENG, Beijing (CN)

(21) Appl. No.: 14/564,891

(22) Filed: Dec. 9, 2014

(30) Foreign Application Priority Data
Dec. 11, 2013 (CN) 201310676808.7

(51) Int. Cl. H04W 12/02

(52) U.S. Cl. CPC H04W 12/02

(57) ABSTRACT

The present disclosure disclosures a protecting system and method for privacy information in a mobile terminal. In the system, a crowdsourcing database stores security strategy information of applications. An interaction management module receives a recommendation request of security strategy sent by the mobile terminal. A recommendation algorithm module calculates according to the recommendation request of security strategy to obtain corresponding recommended security strategy. An interaction management module recommends the recommended security strategy to the privacy protecting module. A privacy protecting module notifies a user and assists the mobile terminal to set privacy protection strategy according to the recommended security strategy recommended by the interaction management module, and protects the privacy information in the mobile terminal according to the privacy protection strategy. The system can set privacy protection dynamically. In this way, user experience is improved.

### CROSS-REFERENCE TO RELATED APPLICATION

This application claims priority to and benefits of Chinese Patent Application Serial No. 201310676808.7, filed with the State Intellectual Property Office of P. R. China on Dec. 11, 2013, the entire contents of which are incorporated herein by reference.

### FIELD

The present disclosure relates to information security technology, and more particularly, to a protecting system and method for privacy information in a mobile terminal.

### BACKGROUND

Because of wide use of smart mobile terminals (such as smart phones, tablet computers etc.), in order to achieve a humanized user experience, applications developed and used in the smart mobile terminals often obtain a lot of user's privacy information to achieve customization of the applications. However, in the process of obtaining the privacy information in the mobile terminal, leak of the privacy information may happen. There are some situations that may cause privacy leak: 1) in order to achieve customization, the privacy information in the mobile terminal usually needs to be uploaded to a backend server of the application by network and it may cause privacy leak during the network transmission process; 2) application developers or running companies sell privacy illegally to a third party; 3) application developers obtain the privacy information in the mobile terminal for no relevant function in excuse of information collection, etc. Therefore, protection problem of the privacy information in the mobile terminal has become prominent and needs to be solved.

In the operating system currently-used in the mobile terminal, such as Android operating system, privacy protection mechanisms thereof need the application developers to show type of the privacy information which their applications involve in terms of service. Before a user installs the application, it needs to inform the user of the terms of service firstly, and then the user decides whether he or she agrees with the terms of service after reading. If yes, then the application is installed, and if no, then the application cannot be installed. However, there are several problems existing in the above process.

1) the terms of service may include other content besides the access declaration of privacy information. Thus, the content is integrated with complexity, and it is difficult for the user to find desired information. Meanwhile, content of the terms of service is obscure, and it is difficult for the user to understand the exact usage of the privacy information which the application obtains and it is difficult for the user to decide whether to agree such terms of service; 2) one application often needs to obtain many types of privacy information. If the user needs to install this application, he or she must agree all obtaining requests of privacy information. Privacy information which does not influence normal use of the application may exist in these obtaining requests. Therefore, it results in over-obtaining privacy information; 3) after the application has been installed, if the user finds that the privacy information which the application obtains is not for the application function. In order to protect his or her privacy information, the user has to delete the application, so that the normal function of the application cannot be used any more.

### SUMMARY

In our implementation, a protecting system for privacy information in a mobile terminal is provided. The system allows a user to set privacy protection dynamically in execution of the application. The system protects the privacy information in the mobile terminal while ensuring that the application can be used normally. In this way, user experience is improved.

In our implementation, a protecting method for privacy information in a mobile terminal is provided.

A protecting system for privacy information in a mobile terminal includes: a crowdsourcing database, an interaction management module, a recommendation algorithm module and a privacy protecting module. The crowdsourcing database, the interaction management module and the recommendation algorithm module are set in a server. The privacy protecting module is set in the mobile terminal. The crowdsourcing database is configured to store security strategy information of applications. The interaction management module is configured to receive a recommendation request of security strategy sent by the mobile terminal. The recommendation algorithm module is configured to calculate according to the recommendation request of security strategy to obtain corresponding recommended security strategy. The interaction management module is further configured to recommend the recommended security strategy to the privacy protecting module. The privacy protecting module is configured to notify a user and assist the mobile terminal to set privacy protection strategy according to the recommended security strategy recommended by the interaction management module, and configured to protect the privacy information in the mobile terminal according to the privacy protection strategy.

According to the protecting system for the privacy information in the mobile terminal in the embodiment of the present disclosure, the interaction management module receives the recommendation request of security strategy sent by the mobile terminal. The recommendation algorithm module calculates according to the recommendation request of security strategy to obtain corresponding recommended security strategy. The interaction management module recommends the recommended security strategy to the privacy protecting module. The privacy protecting module notifies the user and assists the mobile terminal to set the privacy protection strategy according to the recommended security strategy to protect the privacy information in the mobile terminal according to the privacy protection strategy. Compared with conventional privacy information security protection mechanism, the system has simpler and better user experience, and meanwhile, the user can set privacy protection dynamically in execution of the application. The system protects the privacy information in the mobile terminal while ensuring that the application can be used normally.

A protecting method for privacy information in a mobile terminal includes following steps:

a crowdsourcing database storing security strategy information of applications, wherein the crowdsourcing database is set in a server;

an interaction management module receiving a recommendation request of security strategy sent by the mobile terminal, wherein the interaction management module is set in the server;

a recommendation algorithm module calculating according to the recommendation request of security strategy to obtain corresponding recommended security strategy, wherein the recommendation algorithm module is set in the sever;

the interaction management module recommending the recommended security strategy to a privacy protecting module; and

the privacy protecting module notifying a user and assisting the mobile terminal to set privacy protection strategy according to the recommended security strategy recommended by the interaction management module, and protecting the privacy information in the mobile terminal according to the privacy protection strategy, wherein the privacy protecting module is set in the mobile terminal.

According to the protecting method for the privacy information in the mobile terminal in the embodiment of the present disclosure, the interaction management module receives the recommendation request of security strategy sent by the mobile terminal. The recommendation algorithm module calculates according to the recommendation request of security strategy to obtain corresponding recommended security strategy. The interaction management module recommends the recommended security strategy to the privacy protecting module. The privacy protecting module notifies the user and assists the mobile terminal to set the privacy protection strategy according to the recommended security strategy to protect the privacy information in the mobile terminal according to the privacy protection strategy. Compared with conventional privacy information security protection mechanism, the method has simpler and better user experience, and meanwhile, the user can set privacy protection dynamically in execution of the application. The method protects the privacy information in the mobile terminal while ensuring that the application can be used normally.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions taken in conjunction with the drawings in which:

FIG. 1 is a block diagram of a protecting system for privacy information in a mobile terminal, according to an embodiment of the present disclosure;

FIG. 2 is a flow chart of a protecting method for privacy information in a mobile terminal, according to an embodiment of the present disclosure;

FIG. 3 is a flow chart of a specific implementation of the protecting method for privacy information in a mobile terminal, according to an embodiment of the present disclosure.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

Following are descriptions of a protecting system and a protecting method for privacy information in a mobile terminal along with the drawings.

FIG. 1 is a block diagram of a protecting system for privacy information in a mobile terminal, according to an embodiment of the present disclosure.

As shown in FIG. 1, the protecting system for privacy information in the mobile terminal includes a crowdsourcing database 100, an interaction management module 200, a recommendation algorithm module 300 and a privacy protecting module 400. In the embodiment of the present disclosure, the crowdsourcing database 100, the interaction management module 200 and the recommendation algorithm module 300 can be set in a server. The privacy protecting module 400 can be set in the mobile terminal.

Specifically, the crowdsourcing database 100 is configured to store security strategy information of applications. The interaction management module 200 is configured to receive a recommendation request of security strategy sent by the mobile terminal. The recommendation algorithm module 300 is configured to calculate according to the recommendation request of security strategy to obtain corresponding recommended security strategy. The interaction management module 200 is further configured to recommend the recommended security strategy to the privacy protecting module 400. The privacy protecting module 400 is configured to notify a user and assist the mobile terminal to set privacy protection strategy according to the recommended security strategy recommended by the interaction management module 200 and configured to protect the privacy information in the mobile terminal according to the privacy protection strategy. The security strategy information can include privacy types and corresponding values. In addition, the recommendation request of security strategy can include an identifier of an application, a version number of an application and the privacy type, etc.

In the embodiment of the present disclosure, the crowdsourcing database 100 can be a key-value database. For example, as shown in the following Table 1, key is a string spliced by the identifier of the to-be-installed/installed application and the version number of the to-be-installed/installed application in the mobile terminal. Value is a Dictionary Set of the security strategy information corresponding to the application. The Dictionary Set can be “privacy type” as keys, such as “GPS (global positioning system) position”, “network location”, “contact list”, “UDID (unique device identity) of the mobile terminal”, etc. Each of the values corresponding to these privacy types can include three keys of “number of strategy which a user permits”, “number of strategy which a user refuses”, “total number of strategy” and the Dictionary Set as the value corresponding to the key. In this way, the query speed is increased and the storage quantity is expanded.

TABLE 1

| key | value | | |
|---|---|---|---|
| | key | value | |
| | | key | value |
| identifier of a | GPS position | Number of strategy which a user | {value} |
| application + | | permits | |
| “#” + version | | Number of strategy which a user | {value} |
| number of a | | refuses | |
| application | | Total number of strategy | {value} |
| | Network | Number of strategy which a user | {value} |
| | location | permits | |
| | | Number of strategy which a user | {value} |
| | | refuses | |
| | | Total number of strategy | {value} |
| | Contact list | Number of strategy which a user | {value} |
| | | permits | |
| | | Number of strategy which a user | {value} |
| | | refuses | |
| | | Total number of strategy | {value} |
| | UDID of the | Number of strategy which a user | {value} |
| | mobile | permits | |
| | terminal | Number of strategy which a user | {value} |
| | | refuses | |
| | | Total number of strategy | {value} |

For example, after receiving the recommendation request of security strategy sent by the mobile terminal, first, the interaction management module 200 can obtain two parameters: the identifier of the application and the version number of the application in the recommendation request of security strategy, and then splices the two parameters as the string, such as {“the identifier of the application”+“#”+“the version number of the application”}, and inquires in the crowdsourcing database 100 according to the string as key to obtain strategy data of all “privacy types” corresponding to the application. Then, the interaction management module 200 can obtain the “privacy type” parameter in the recommendation request of security strategy, and then obtain the strategy data of the “privacy type” in the strategy data of all “privacy types”. The recommendation algorithm module 300 calculates according to the strategy data to obtain the recommended security strategy corresponding to the recommendation request of security strategy. The interaction management module 200 can recommend the recommended security strategy to the privacy protecting module 400. The privacy protecting module 400 can notify the user and assist the mobile terminal to set the privacy protection strategy according to the recommended security strategy to protect the privacy information in the mobile terminal.

It is noted that, in the embodiment of the present disclosure, when the interaction management module 200 inquires in the crowdsourcing database 100 according to the recommendation request of security strategy, if no strategy data corresponding to the recommendation request of security strategy is obtained, then the server can return error information to notify the user. For example, the notification can be “no recommended security strategy can be recommended in the server, set security strategy manually?”, etc.

Preferably, in one embodiment of the present disclosure, as shown in FIG. 1, the protecting system for the privacy information in the mobile terminal can further include a communication module 500. The communication module 500 can be set in the mobile terminal. The interaction management module 200 and the privacy protecting module 400 communicate with each other via the communication module 500. For example, the privacy protecting module 400 can send the recommendation request of security strategy to the interaction management module 200 via the communication module 500, and the interaction management module 200 can send the recommended security strategy to the privacy protecting module 400 via the communication module 500.

Preferably, in one embodiment of the present disclosure, as shown in FIG. 1, the protecting system for the privacy information in the mobile terminal further includes a determining module 600. In the embodiment of the present disclosure, the privacy protecting module 400 is further configured to detect privacy access actions of the application in the mobile terminal and configured to send the recommendation request of security strategy to the server according to the access actions and inquire in a preset database to obtain corresponding security strategy according to the recommendation request of security strategy. The determining module 600 is configured to, when the recommended security strategy is requested successfully, determine whether the security strategy is the same as the recommended security strategy. The privacy protecting module 400 is further configured to, when the determining module 600 determines that the security strategy is the same as the recommended security strategy, keep protecting the privacy information in the mobile terminal according to the security strategy or the recommended security strategy and configured to, when the determining module 600 determines that the security strategy is not the same as the recommended security strategy, notify the user to choose the recommended security strategy. The preset database mentioned can be set in the mobile terminal and can store the security strategy set by the user.

In the embodiment of the present disclosure, data format stored in the preset database can be key-value data format. For example, as shown in the following Table 2, key is a string spliced by the identifier of the to-be-installed/installed application and the version number of the to-be-installed/installed application in the mobile terminal. Value is a Dictionary Set of the security strategy information corresponding to the application. The Dictionary Set can include four keys of “GPS (global positioning system) position”, “network location”, “contact list”, “UDID of the mobile terminal” and four values corresponding to the four keys. Value can be “0” or “1”. “0” stands for “nermission” and “1” stands for “refusal”.

TABLE 2

| key | value | |
|---|---|---|
| | key | value |
| identifier of a application + “#” + version | GPS position | 0 or 1 |
| number of a application | Network location | 0 or 1 |
| | Contact list | 0 or 1 |
| | UDID of mobile | 0 or 1 |
| | terminal | |

For example, the operating system of the mobile terminal is an Android operating system. The privacy protecting module 400 hangs a hook into method Qury by HOOK technology to detect the actions of the application accessing four types of privacy information in ContentResolver of system framework android.Content of the Android operating system. The four types of privacy information can be GPS position information of the mobile terminal, network location information of the mobile terminal, contact list of the mobile terminal and UDID of the mobile terminal. Then the privacy protecting module 400 sends the recommendation request of security strategy to the server according to the access actions and inquires in the preset database to obtain corresponding security strategy according to the recommendation request of security strategy. When the privacy protecting module 400 requests the recommended security strategy successfully and the security strategy corresponding to the recommendation request of security strategy exists in the preset database, the determining module 600 determines whether the security strategy is the same as the recommended security strategy. If yes, the privacy protecting module 400 keeps protecting the privacy information in the mobile terminal according to the security strategy or the recommended security strategy. If no, the privacy protecting module 400 can notify the user whether to change to use the recommended security strategy. It is noted that, in the embodiment of the present disclosure, when no security strategy corresponding to the recommendation request of security strategy exists in the preset database, the privacy protecting module 400 notifies the user whether to use the recommended security strategy.

It is noted that, in the embodiment of the preset disclosure, when the privacy protecting module 400 fails to request the recommended security strategy from the server (such as no security strategy information corresponding to the recommendation request of security strategy exists in the crowdsourcing database 100) and the security strategy corresponding to the recommendation request of security strategy exists in the preset database, the privacy protecting module 400 sets the privacy protection strategy of the mobile terminal according to the security strategy in the preset database to protect the privacy information in the mobile terminal. For example, when the security strategy is “permission” in the preset database, real privacy information in system of the mobile terminal can be obtained and returned to the user. When the security strategy is “refusal” in the preset database, fake information can be generated by modeling the privacy information and can be returned to the user. When no security strategy corresponding to the recommendation request of security strategy exists in the preset database, the privacy protecting module 400 can notify the user to manually set the security strategy. The security strategy can include “permission” and “refusal”, etc.

It is further noted that, in the embodiment of the present disclosure, the security strategy, set or created manually by the user or modified by the user, can be stored in the preset database and can be labeled as to-be-uploaded.

In order to expand data information of the crowdsourcing database 100 continuously, in one embodiment of the present disclosure, the privacy protecting module 400 is further configured to, when a network of the mobile terminal is idle, upload the security strategy in the preset database to the server. For example, the privacy protecting module 400 can regularly scan the network status of the mobile terminal, and when detecting that the network of the mobile terminal is idle, the privacy protecting module 400 uploads the to-be-uploaded security strategy in the preset database to the server via the communication module 500. Upload parameters can include “security strategy”, the identifier of the application and the version number of the application, etc.

It is noted that, in the embodiment of the present disclosure, the interaction management module 200 is further configured to receive the to-be-uploaded security strategy in the preset database that sent by the mobile terminal. Specifically, after the privacy protecting module 400 uploads the to-be-loaded security strategy in the preset database to the server, the interaction management module 200 determines whether security strategy information corresponding to the application exists in the crowdsourcing database 100 according to the identifier of the application and the version number of the application in the upload parameters, and if no, then obtains the “security strategy” in the upload parameters and creates the security strategy information corresponding to the application in the crowdsourcing database 100 according to the “security strategy” in the upload parameters. For example, the interaction management module 200 can obtain the value of the “security strategy” in the upload parameters and update data in the crowdsourcing database 100 by adding 1 to “total number of strategy” in the crowdsourcing database 100. In addition, when value is “0”, the interaction management module 200 can add 1 to “number of strategy which a user permits” in the crowdsourcing database 100, and when value is “1”, the interaction management module 200 can add 1 to “number of strategy which a user refuses” in the crowdsourcing database 100.

According to the protecting system for the privacy information in the mobile terminal in the embodiment of the present disclosure, the interaction management module 200 receives the recommendation request of security strategy sent by the mobile terminal. The recommendation algorithm module 300 calculates according to the recommendation request of security strategy to obtain corresponding recommended security strategy. The interaction management module 200 recommends the recommended security strategy to the privacy protecting module 400. The privacy protecting module 400 notifies the user and assists the mobile terminal to set the privacy protection strategy according to the recommended security strategy to protect the privacy information in the mobile terminal according to the privacy protection strategy. Compared with conventional privacy information security protection mechanism, the system has simpler and better user experience, and meanwhile, the user can set privacy protection dynamically in execution of the application. The system protects the privacy information in the mobile terminal while ensuring that the application can be used normally.

To implement the above embodiment, a protecting method for the privacy information in the mobile terminal is provided according to an embodiment of the present disclosure.

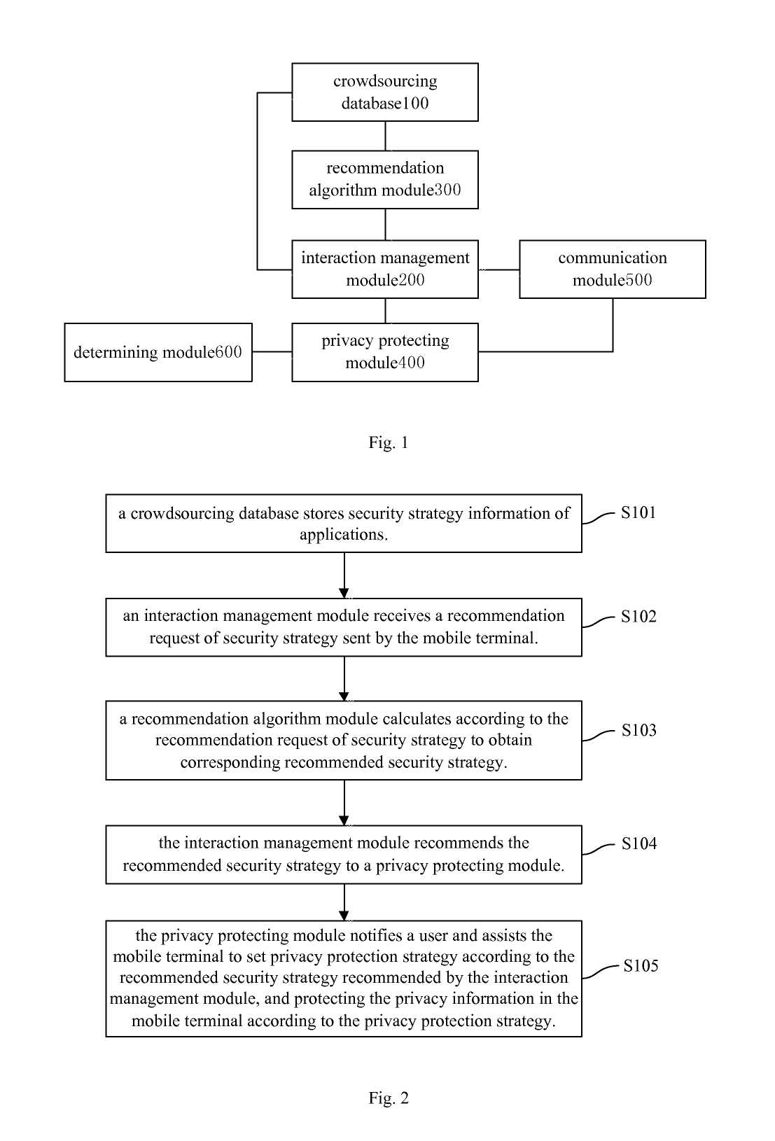

FIG. 2 is a flow chart of a protecting method for the privacy information in the mobile terminal, according to an embodiment of the present disclosure.

As shown in FIG. 2, the protecting method for the privacy information in the mobile terminal includes following steps:

S101, a crowdsourcing database stores security strategy information of applications, wherein the crowdsourcing database is set in a server.

The security strategy information can include privacy types and corresponding values.

Additionally, in the embodiment of the present disclosure, the crowdsourcing database can be a key-value database. For example, as shown in the following Table 1, key is a string spliced by the identifier of the to-be-installed/installed application and the version number of the to-be-installed/installed application in the mobile terminal. Value is a Dictionary Set of the security strategy information corresponding to the application. The Dictionary Set can be “privacy type” as keys, such as “GPS (global positioning system) position”, “network location”, “contact list”, “UDID (unique device identifier) of the mobile terminal”, etc. Each of the values corresponding to these privacy types can include three keys of “number of strategy which a user permits”, “number of strategy which a user refuses”, “total number of strategy” and the Dictionary Set as the value corresponding to the key. In this way, the query speed is increased and the storage quantity is expanded.

TABLE 1

| key | value | | |
|---|---|---|---|
| | key | value | |
| | | key | value |
| identifier of a | GPS position | Number of strategy which a user | {value} |
| application + | | permits | |
| “#” + version | | Number of strategy which a user | {value} |
| number of a | | refuses | |
| application | | Total number of strategy | {value} |
| | Network | Number of strategy which a user | {value} |
| | location | permits | |
| | | Number of strategy which a user | {value} |
| | | refuses | |
| | | Total number of strategy | {value} |
| | Contact list | Number of strategy which a user | {value} |
| | | permits | |
| | | Number of strategy which a user | {value} |
| | | refuses | |
| | | Total number of strategy | {value} |
| | UDID of the | Number of strategy which a user | {value} |
| | mobile | permits | |
| | terminal | Number of strategy which a user | {value} |
| | | refuses | |
| | | Total number of strategy | {value} |

S102, an interaction management module receives a recommendation request of security strategy sent by the mobile terminal, where the interaction management module is set in the server.

S103, a recommendation algorithm module calculates according to the recommendation request of security strategy to obtain corresponding recommended security strategy, where the recommendation algorithm module is set in the sever.

The recommendation request of security strategy can include an identifier of an application, a version number of an application and the privacy type, etc.

For example, after receiving the recommendation request of security strategy sent by the mobile terminal, first, the interaction management module can obtain two parameters: the identifier of the application and the version number of the application in the recommendation request of security strategy, and then splices the two parameters as the string, such as {“the identifier of the application”+“#”+“the version number of the application”}, and inquires in the crowdsourcing database according to the string as key to obtain strategy data of all “privacy types” corresponding to the application. Then, the interaction management module can obtain the “privacy type” parameter in the recommendation request of security strategy, and then obtain the strategy data of the “privacy type” in the strategy data of all “privacy types”. The recommendation algorithm module calculates according to the strategy data to obtain the recommended security strategy corresponding to the recommendation request of security strategy.

S104, the interaction management module recommends the recommended security strategy to a privacy protecting module.

S105, the privacy protecting module notifies a user and assists the mobile terminal to set privacy protection strategy according to the recommended security strategy recommended by the interaction management module, and protecting the privacy information in the mobile terminal according to the privacy protection strategy, where the privacy protecting module is set in the mobile terminal.

It is noted that, in the embodiment of the present disclosure, when the interaction management module inquires in the crowdsourcing database according to the recommendation request of security strategy, if no strategy data corresponding to the recommendation request of security strategy is obtained, then the server can return error information to notify the user. For example, the notification can be “no recommended security strategy can be recommended in the server, set security strategy manually?”, etc.

It is further noted that, in one embodiment of the present disclosure, the interaction management module and the privacy protecting module communicate with each other via a communication module. The communication module can be set in the mobile terminal. For example, the interaction management module can send the recommended security strategy to the privacy protecting module via the communication module. It is understood that the privacy protecting module can send the recommendation request of security strategy to the interaction management module via the communication module as well.

According to the protecting method for the privacy information in the mobile terminal in the embodiment of the present disclosure, the interaction management module receives the recommendation request of security strategy sent by the mobile terminal. The recommendation algorithm module calculates according to the recommendation request of security strategy to obtain corresponding recommended security strategy. The interaction management module recommends the recommended security strategy to the privacy protecting module. The privacy protecting module notifies the user and assists the mobile terminal to set the privacy protection strategy according to the recommended security strategy to protect the privacy information in the mobile terminal according to the privacy protection strategy. Compared with conventional privacy information security protection mechanism, the method has simpler and better user experience, and meanwhile, the user can set privacy protection dynamically in execution of the application. The method protects the privacy information in the mobile terminal while ensuring that the application can be used normally.

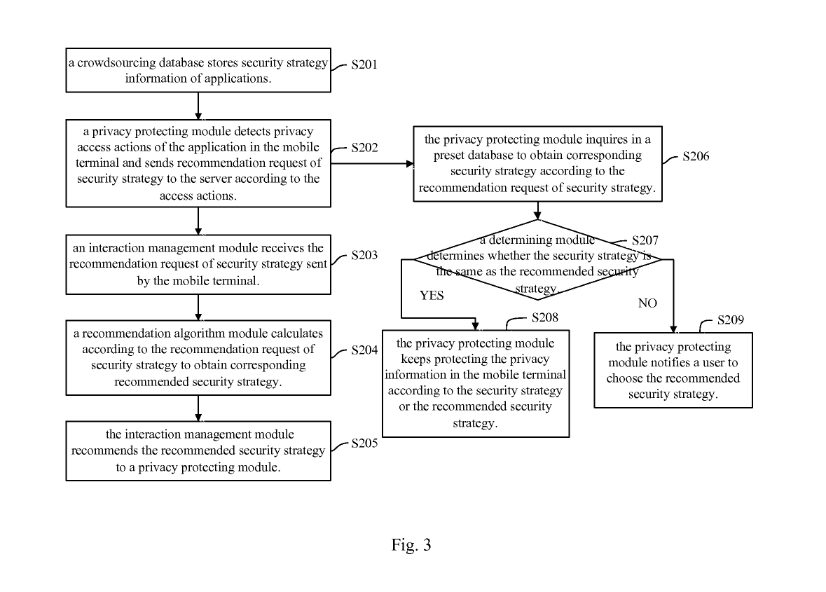

FIG. 3 is a flow chart of a specific implementation of the protecting method for privacy information in a mobile terminal, according to an embodiment of the present disclosure.

As shown in FIG. 3, the protecting method for the privacy information in the mobile terminal, includes following steps:

S201, a crowdsourcing database stores security strategy information of applications, wherein the crowdsourcing database is set in a server.

The security strategy information can include privacy types and corresponding values.

Additionally, in the embodiment of the present disclosure, the crowdsourcing database can be a key-value database. For example, as shown in the following Table 1, key is a string spliced by the identifier of the to-be-installed/installed application and the version number of the to-be-installed/installed application in the mobile terminal. Value is a Dictionary Set of the security strategy information corresponding to the application. The Dictionary Set can be “privacy type” as keys, such as “GPS (global positioning system) position”, “network location”, “contact list”, “ID (identity) of the mobile terminal”, etc. Each of the values corresponding to these privacy types can include three keys of “number of strategy which a user permits”, “number of strategy which a user refuses”, “total number of strategy” and the Dictionary Set of the value corresponding to the key. In this way, a query speed is increased and a storage quantity is expanded.

S202, a privacy protecting module detects privacy access actions of the application in the mobile terminal and sends recommendation request of security strategy to the server according to the access actions.

For example, the operating system of the mobile terminal is an Android operating system. The privacy protecting module hangs a hook into method Qury by HOOK technology to detect the actions of the application accessing four types of privacy information in ContentResolver of system framework android.Content of the Android operating system. The four types of privacy information can be GPS position information of the mobile terminal, network location information of the mobile terminal, contact list of the mobile terminal and UDID of the mobile terminal. Then the privacy protecting module sends the recommendation request of security strategy to the server according to the access actions.

S203, an interaction management module receives the recommendation request of security strategy sent by the mobile terminal, where the interaction management module is set in the server.

S204, a recommendation algorithm module calculates according to the recommendation request of security strategy to obtain corresponding recommended security strategy, where the recommendation algorithm module is set in the sever.

The recommendation request of security strategy can include an identifier of an application, a version number of an application and privacy type, etc.

For example, after receiving the recommendation request of security strategy sent by the mobile terminal, first, the interaction management module can obtain two parameters: the identifier of the application and the version number of the application in the recommendation request of security strategy in the recommendation request of security strategy, and then splices the two parameters as the string, such as {“the identifier of the application”+“#”+“the version number of the application”}, and inquires in the crowdsourcing database according to the string as key to obtain strategy data of all “privacy types” corresponding to the application. Then, the interaction management module can obtain the “privacy type” parameter in the recommendation request of security strategy, and then obtain the strategy data of the “privacy type” parameter in the strategy data of all “privacy types” according to the “privacy type” parameter. The recommendation algorithm module calculates according to the strategy data to obtain the recommended security strategy corresponding to the recommendation request of security strategy.

S205, the interaction management module recommends the recommended security strategy to a privacy protecting module, where the privacy protecting module is set in the mobile terminal.

S206, the privacy protecting module inquires in a preset database to obtain corresponding security strategy according to the recommendation request of security strategy.

In the embodiment of the present disclosure, the preset database mentioned can be set in the mobile terminal and can store security strategy set by the user. Data format stored in the preset database can be key-value data format. For example, as shown in the following Table 2, key is a string spliced by the identifier of the to-be-installed/installed application and the version number of the to-be-installed/installed application in the mobile terminal. Value is a Dictionary Set of the security strategy information corresponding to the application. The Dictionary Set can include four keys of “GPS (global positioning system) position”, “network location”, “contact list”, “ID of the mobile terminal” and four values corresponding to the four keys. Value can be “0” or “1”. “0” stands for “permission” and “1” stands for “refusal”.

TABLE 2

| key | value | |
|---|---|---|
| | key | value |
| identifier of a application + “#” + version | GPS position | 0 or 1 |
| number of a application | Network location | 0 or 1 |
| | Contact list | 0 or 1 |
| | UDID of mobile | 0 or 1 |
| | terminal | |

S207, when the recommended security strategy is requested successfully, a determining module determines whether the security strategy is the same as the recommended security strategy.

When the privacy protecting module requests the recommended security strategy successfully and the security strategy corresponding to the recommendation request of security strategy exists in the preset database, the determining module determines whether the security strategy is the same as the recommended security strategy. It is understood that, in the embodiment of the present disclosure, when no security strategy corresponding to the recommendation request of security strategy exists in the preset database, the privacy protecting module notifies the user whether to use the recommended security strategy.

S208, if the determining module determines that the security strategy is the same as the recommended security strategy, the privacy protecting module keeps protecting the privacy information in the mobile terminal according to the security strategy or the recommended security strategy, which both are the same; and

S209, if the determining module determines that the security strategy is not the same as the recommended security strategy, the privacy protecting module notifies a user to choose the recommended security strategy.

It is noted that, in an embodiment of the preset disclosure, when the privacy protecting module fails to request the recommended security strategy from the server (such as no security strategy information corresponding to the recommendation request of security strategy exists in the crowdsourcing database) and the security strategy corresponding to the recommendation request of security strategy exists in the preset database, the privacy protecting module sets the privacy protection strategy of the mobile terminal according to the security strategy in the preset database to protect the privacy information in the mobile terminal. For example, when the security strategy is “permission” in the preset database, real privacy information in system of the mobile terminal can be obtained and returned to the user. When the security strategy is “refusal” in the preset database, fake information can be generated by modeling the privacy information and can be returned to the user. When no security strategy corresponding to the recommendation request of security strategy exists in the preset database, the privacy protecting module can notify the user to manually set the security strategy. The security strategy can include “permission” and “refusal”, etc.

It is further noted that, in the embodiment of the present disclosure, the security strategy, set or created manually by the user or modified by the user, can be stored in the preset database and can be labeled as to-be-uploaded.

In order to expand data information of the crowdsourcing database continuously, in one embodiment of the present disclosure, the privacy protecting module is further configured to, when a network of the mobile terminal is idle, upload the security strategy in the preset database to the server. For example, the privacy protecting module can regularly scan the network status of the mobile terminal, and when detecting that the network of the mobile terminal is idle, the privacy protecting module uploads the to-be-uploaded security strategy in the preset database to the server via the communication module. Upload parameters can include “security strategy”, the identifier of the application and the version number of the application, etc.

It is noted that, in the embodiment of the present disclosure, the interaction management module is further configured to receive the to-be-uploaded security strategy in the preset database that sent by the mobile terminal. Specifically, after the privacy protecting module uploads the to-be-loaded security strategy in the preset database to the server, the interaction management module determines whether security strategy information corresponding to the application exists in the crowdsourcing database according to the identifier of the application and the version number of the application in the upload parameters, and if no, then obtains the “security strategy” in the upload parameters and creates the security strategy information corresponding to the application in the crowdsourcing database according to the “security strategy” in the upload parameters. For example, the interaction management module can obtain the value of the “security strategy” in the upload parameters and update data in the crowdsourcing database by adding 1 to “total number of strategy” in the crowdsourcing database. In addition, when value is “0”, the interaction management module can add 1 to “number of strategy which a user permits” in the crowdsourcing database, and when value is “1”, the interaction management module can add 1 to “number of strategy which a user refuses” in the crowdsourcing database.

According to the protecting method for the privacy information in the mobile terminal in the embodiment of the present disclosure, the privacy protecting module inquires in the preset database to obtain corresponding security strategy according to the recommendation request of security strategy. When the recommended security strategy is requested successfully, the determining module determines whether the security strategy is the same as the recommended security strategy. If yes, the privacy protecting module keeps protecting the privacy information in the mobile terminal according to the security strategy or the recommended security strategy. If no, the privacy protecting module notifies the user to choose the recommended security strategy. Therefore, privacy information protection strategy can be obtained widely and availability thereof can be improved.

It is understood that, in the embodiment of the present disclosure, the mobile terminal can be hardware apparatus having Android operating system, such as cell phone, tablet computer, personal digital assistance, E-book.

It is understood that, parts or part of the present disclosure can achieved by hardware, software or combinations thereof. In the above embodiments, multiple steps or methods can be implemented by software or firmware stored in a storage unit and executed by a proper instruction execution system. For example, if the steps or methods are implemented by hardware, any of the following technologies and combination thereof in the art can be used to implement: discrete logic circuits having logic gate circuits configured to enable logic function of data signals, ASIC having a suitable combination of logic gate circuit, programmable gate array (PGA), and a field programmable gate array (FPGA), etc.

Reference throughout this specification to “an embodiment”, “some embodiments”, “one embodiment”, “an example”, “a specific examples”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific examples”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications may be made in the embodiments without departing from spirit and principles of the disclosure. Such changes, alternatives, and modifications all fall into the scope of the claims and their equivalents.

What is claimed is:

1. A protecting system for privacy information in a mobile terminal, comprising: a crowdsourcing database, an interaction management module, a recommendation algorithm module and a privacy protecting module, the crowdsourcing database, the interaction management module and the recommendation algorithm module set in a server, the privacy protecting module set in the mobile terminal, wherein
the crowdsourcing database is configured to store security strategy information of applications;
the interaction management module is configured to receive a recommendation request of security strategy sent by the mobile terminal;
the recommendation algorithm module is configured to calculate according to the recommendation request of security strategy to obtain corresponding recommended security strategy;
the interaction management module is further configured to recommend the recommended security strategy to the privacy protecting module;
the privacy protecting module is configured to notify a user and assist the mobile terminal to set privacy protection strategy according to the recommended security strategy recommended by the interaction management module, and configured to protect the privacy information in the mobile terminal according to the privacy protection strategy.

2. The system of claim 1, further comprising:
a communication module set in the mobile terminal, the interaction management module and the privacy protecting module communicating with each other via the communication module.

3. The system of claim 1, further comprising:
a determining module, wherein the privacy protecting module is further configured to detect privacy access actions of the application in the mobile terminal and configured to send the recommendation request of security strategy to the server according to the access actions and inquire in a preset database to obtain corresponding security strategy according to the recommendation request of security strategy;
the determining module is configured to, when the recommended security strategy is requested successfully, determine whether the security strategy is the same as the recommended security strategy;
the privacy protecting module is further configured to, when the determining module determines that the security strategy is the same as the recommended security strategy, keep protecting the privacy information in the mobile terminal according to the security strategy or the recommended security strategy and configured to, when the determining module determines that the security strategy is not the same as the recommended security strategy, notify the user to choose the recommended security strategy.

4. The system of claim 3, wherein the privacy protecting module is further configured to, when a network of the mobile terminal is idle, upload the security strategy in the preset database to the server.

5. The system of claim 1, wherein the crowdsourcing database is key-value database.

6. A protecting method for privacy information in a mobile terminal, comprising following steps:
a crowdsourcing database storing security strategy information of applications, wherein the crowdsourcing database is set in a server;
an interaction management module receiving a recommendation request of security strategy sent by the mobile terminal, wherein the interaction management module is set in the server;
a recommendation algorithm module calculating according to the recommendation request of security strategy to obtain corresponding recommended security strategy, wherein the recommendation algorithm module is set in the sever;
the interaction management module recommending the recommended security strategy to a privacy protecting module; and
the privacy protecting module notifying a user and assisting the mobile terminal to set privacy protection strategy according to the recommended security strategy recommended by the interaction management module, and protecting the privacy information in the mobile terminal according to the privacy protection strategy, wherein the privacy protecting module is set in the mobile terminal.

7. The method of claim 6, wherein the interaction management module and the privacy protecting module communicates with each other via a communication module set in the mobile terminal.

8. The method of claim 6, further comprising:
the privacy protecting module detecting privacy access actions of the application in the mobile terminal and sending the recommendation request of security strategy to the server according to the access actions;
the privacy protecting module inquiring in a preset database to obtain corresponding security strategy according to the recommendation request of security strategy;
when the recommended security strategy is requested successfully, a determining module determining whether the security strategy is the same as the recommended security strategy;
if the determining module determines that the security strategy is the same as the recommended security strategy, the privacy protecting module keeping protecting the privacy information in the mobile terminal according to the security strategy or the recommended security strategy; and
if the determining module determines that the security strategy is not the same as the recommended security strategy, the privacy protecting module notifying the user to choose the recommended security strategy.

9. The method of claim 8, further comprising:
when a network of the mobile terminal is idle, the privacy protecting module uploading the security strategy in the preset database to the server.

10. The method of claim 6, wherein the crowdsourcing database is key-value database.
